(19) United States
(12) Patent Application Publication
(10) Pub. No.: US 2002/0133246 A1
(43) Pub. Date: Sep. 19, 2002

(54) Method of editing audio data and recording medium thereof and digital audio player

(76) Inventors: Hong-kee Kim, Suwon-city (KR); Sung-pil Choi, Seoul (KR)

Correspondence Address: Robert E. Bushnell, Suite 300, 1522 K Street, N.W., Washington, DC, 20005-1202, US

(21) Appl. No.: 09/796,691

(22) Filed: Mar. 2, 2001

(51) Int. Cl. G06F 17/00

(52) U.S. Cl. 700/94

(57) ABSTRACT

An audio data editing method, recording medium employing the same, and a digital audio player. The digital audio player extracts an audio data, which is received through a key input portion having an editing key for adjusting an extraction data rate and also through an input portion, according to the extraction data rate selected through the key input portion. The digital audio player includes a controller for storing the extracted audio data in a memory portion. According to the audio data editing method, recording medium, and digital audio player, the audio data file can be edited at any scale, and accordingly, the memory capacity of portable digital audio device can be utilized more efficiently.

### BACKGROUND OF THE INVENTION

1. Field of the Invention

The present invention relates to a method of editing audio data and a recording medium employing the same and a digital audio player, and more particularly, to a method of editing audio data according to a scale desired by a user and a recording medium employing such editing method, and a digital audio player.

2. Description of the Related Art

Many suggestions have been proposed about the audio signal encoding method that could provide increased compression rate of the audio signal and the sound most similar to the original sound.

MPEG/audio standard or AC-2/AC-3 method provides the audio quality which is most similar to the sound produced by the compact disc, by reducing a bit rate by one sixth or one eighth from the bit rate of a conventional digital encoder, i.e., generally to 64 Kbps to 384 Kbps.

Meanwhile, steady study also has been made about the ways to provide an audio quality corresponding to the original sound at a lower bit rate. One significant result of the study can be a MPEG-2 Advanced Audio Coding (AAC) which was selected as one of International Standards. The MPEG-2 AAC also was recommended by an expert group as a method that could provide the audio quality corresponding to the original sound at a bit rate of 64 Kbps.

According to general encoders which employ the conventional encoding methods, audio data is encoded by an encoding method which is set in accordance with a fixed bit rate.

Meanwhile, a portable digital audio player is constructed to play the audio file generated by the conventional encoding method by downloading a file from a computer, or a vending machine for audio file supply.

However, since the portable digital audio player is designed to have a limited size for a convenience of a carrier, it is practically impossible to extend the memory capacity of a recording medium beyond a predetermined extent. In other words, the portable digital audio player has a limited memory capacity.

Generally, the portable digital audio player has a memory of limited capacity, such as 16, 32 or 64 Megabytes, which sometimes limits a size or a number of audio files when storing an audio file generated by the conventional encoding methods in the portable digital audio player.

Accordingly, in order to download a digital audio file generated by the conventional encoding methods into the portable digital audio player, a user has to select a digital audio file within a memory limit of the digital audio player. For example, if files of 29 Megabytes are already stored in the recording medium of the digital audio player which has memory capacity of 32 Megabytes, the user is only enabled to additionally download an audio file within the remaining free bytes, i.e., within 3 Megabytes. In the event the user's desired audio file is of 4 Megabytes, the user can not download the audio file, which means the free bytes are not efficiently utilized.

The audio file of 4 Megabytes can be downloaded by deleting a file which has more than 1 Megabytes, however, this causes inconvenience to a user in manipulation, while the deleted file is no longer available.

As described above, the conventional digital audio player or audio file generator of the conventional encoding methods does not satisfy the demand of users who want to reduce the size of the digital audio file to use another digital audio file encoded at a fixed bit rate, even if that means a slight degradation of audio quality. In other words, users usually find the conventional digital audio player or the audio file generator generating the audio files according to conventional encoding methods to be inconvenient, since the users are not allowed to adjust the size of data or bit rates as they wish.

### SUMMARY OF THE INVENTION

The present invention has been made to overcome the above-mentioned problems of the related art, and accordingly, it is an object of the present invention to provide a method for editing digital audio data to a size as a user wishes and thus enhancing the efficiency of memory usage of a digital audio player, and a recording medium employing the editing method, and a digital audio player.

The above object is accomplished by a digital audio player for reproducing a digital audio data stored in a memory portion for storing the audio data, according to the present invention, including a key input portion having an editing key for adjusting a data extraction rate with respect to the audio data input through an input portion, and a controller for extracting audio data received through the input portion according to a data extraction rate selected through the key input section, and storing the extracted audio data in the memory portion.

Preferably, by a manipulation signal input through the editing key, the controller displays a menu on a display portion for selection of a bit rate and/or target extraction data size, and by a selection signal input through the key input portion about the bit rate and/or target extraction data size, the controller extracts received audio data according to the corresponding extraction rate and stores the data in the memory portion.

Also, by the manipulation signal input through the editing key, the controller displays a free memory capacity of the memory portion available for data storage on the display portion.

Further, on receipt of bit stream data formed according to a layered bit sliced arithmetic coding method through the input portion, the controller receives data having a bit rate corresponding to the selected extraction rate, and stores the data in the memory portion.

It is more preferable to further include a bit sliced codec portion for performing a layered bit sliced encoding process. The controller extracts audio data received through the input portion according to the data extraction rate selected through the key input portion and controls the bit sliced codec portion to encode the audio data according to a layered bit sliced arithmetic coding method, and stores the extracted and encoded audio data in the memory portion.

The input portion includes at least one of an interface for supporting a bi-directional communication with a computer, a microphone for receiving an audio signal from a user, and an input terminal for receiving audio signal output from an external device.

The bit sliced codec portion includes a quantizing portion for quantizing input audio data for predetermined coding bands, and a bit packing portion for generating a layered bit stream by an order of importance, by expressing the quantization data in a binary notion of a predetermined number of bits, coupling the data in bit unit, and encoding the data from a top bit sequence having the most significant bits to a lower bit sequence having the least significant bits.

The bit sliced codec portion also includes a bit stream analyzing portion for analyzing importance of the bits composing the bit streams and decoding the layered bit streams by an order of layer generation, from the most important bit to the least important bit, an inverse-quantizing portion for restoring the data decoded by the bit stream analyzing portion into an original-sized signal, and a frequency/time mapping portion for converting the audio signal in a frequency domain inversely quantized by the inverse-quantizing portion into a signal in a temporal domain.

The above object is also accomplished by a method for editing a digital audio file on a computer according to a certain data extraction rate, according to another aspect of the present invention, including the steps of providing an editing menu having items for selection about data extraction rates; if received, a signal about a selection of the data extraction rate from the editing menu, editing the audio file at the selected extraction rate according to the layered bit sliced arithmetic coding method; and storing the edit completed audio data in a selected place.

The above object is further accomplished by a recording medium read and executed by a computer, according to yet another aspect of the present invention, including a menu providing portion read and executed by a computer, and when receiving an execution signal, the menu providing portion for providing a plurality of menus including an editing menu for an audio file on a display device; and an editing portion, when the data extraction rate about the audio file for editing is selected through the menu providing portion, the editing portion for generating an audio file by converting the data according to the selected data extraction rate from the audio file according to a layered bit sliced arithmetic coding method.

It is preferable that the bit rate selection menu is offered such that the bit rate is chosen at intervals of 1 Kbps, and the target extraction data size is chosen at intervals at least of 1 Kilobyte.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram showing a computer having an audio editor according to the present invention;

FIG. 2 is a view showing an example of a menu screen provided by a menu providing portion of the audio editor shown in FIG. 1;

FIGS. 3A˜3D are views showing an example of editing menu including an extraction rate selection menu successively provided when the edit menu item of FIG. 2 is selected;

FIG. 4 is a flow chart for explaining a process of extracting data on a computer according to one preferred embodiment of the present invention;

FIG. 5A is a block diagram showing a digital audio player according to one preferred embodiment of the present invention;

FIG. 5B is a view showing an example of an editing menu including an extraction rate selection menu successively provided when an editing function in the digital audio player shown in FIG. 5A is selected;

FIG. 6 is a flow chart for explaining an example of extracting data in the digital audio player shown in FIG. 5A;

FIG. 7 is a block diagram showing elements of a bit sliced encoder of a bit sliced codec employed in the present invention;

FIG. 8 is a view for explaining a bit sliced coding process performed by the bit sliced encoder shown in FIG. 7;

FIG. 9 is a view showing the structure of a layered bit stream generated by the bit sliced coding process; and

FIG. 10 is a block diagram showing elements of the bit sliced decoder of the bit sliced codec employed in the present invention.

### DETAILED DESCRIPTION OF PREFERRED EMBODIMENT

A method for editing audio data and a recording medium employing the same, and a digital audio player according to the preferred embodiment of the present invention will be described in greater detail with reference to the accompanying drawings.

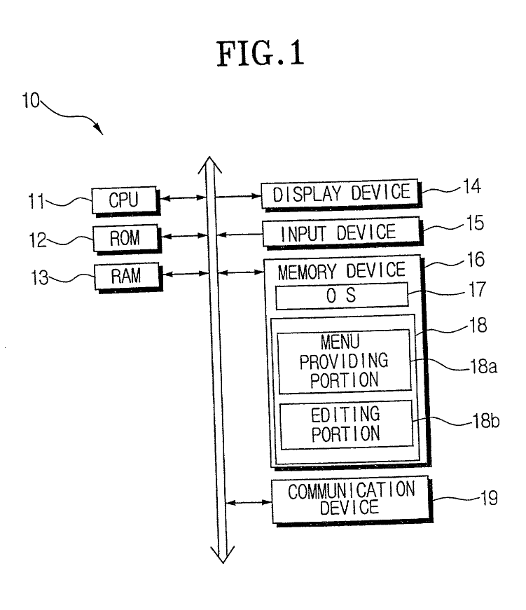

FIG. 1 is a block diagram showing a computer having an audio editing program according to one preferred embodiment of the present invention.

As shown in FIG. 1, the computer 10 includes a central processing unit (CPU) 11, a ROM 12, a RAM 13, a display device 14, an input device 15, a memory device 16, and a communication device 19.

The memory device 16 includes an operating systems (OS) 17 such as Windows98, Windows2000, etc., and an audio editor 18 installed therein.

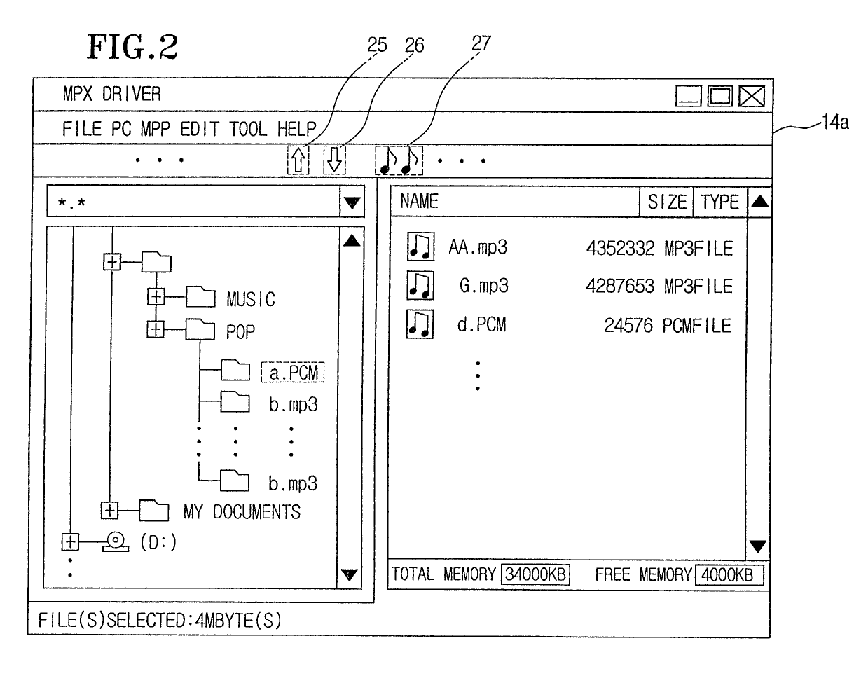

The audio editor 18 provides a menu for editing audio files with the support of the OS 17, and performs processes corresponding to a selection made by a user. The audio editor 18 includes a menu providing portion 18a, and an editing portion 18b. The menu providing portion 18a provides a screen that shows various menus of audio editing when the audio editor 18 is executed on the computer 10. An example of the menu screen of the menu providing portion 18a is shown in FIG. 2.

The editing portion 18b performs processes according to the selection made from the menu provided by the menu providing portion 18a. The editing portion 18b includes a bit sliced codec program, i.e., Bit Sliced Arithmetic Coding (BSAC), which performs a layered bit sliced coding of the digital audio data.

Preferably, the audio editor 18 is constructed such that it supports viewing and selecting of the files stored in the memory device 16 of the computer 10 and also an external device which is connected to a predetermined communication port such as a parallel port or a serial port.

For example, the menu providing portion 18 provides an environment setup menu from which a communication port of the computer 10 can be selected, and the editing portion 18b processes to show the file list stored in the external device connected to the predetermined communication port and the file list stored in the computer 10, on the same screen for comparison.

Further, it is preferable that the audio editor 18 is constructed to play the edit-completed audio file on the computer 10. That is, the bit sliced codec program of the audio editor 18 preferably further includes a decoder for decoding a file generated by the BSAC method.

As shown in FIG. 2, on a screen 14a of the display device 14 which is displayed by executing the audio editor 18, a list of files stored in the memory device 16 of the computer 10 is shown in the left half of the screen, while the list of files stored in a external device connected to a predetermined communication port is shown in the right half of the screen. For example, when the external device connected to the predetermined communication port is a portable digital audio player, the file list stored in the memory portion of the portable digital audio player is shown together with the file list of the computer 10.

An item ‘FILE’ of the menu is a representative symbol supporting command items such as file selecting, file downloading, file uploading, file opening, file saving, and environment setup, etc.

An item ‘EDIT’ of the menu is a representative symbol supporting selections about editing options of the selected file.

Reference numerals 25, 26, and 27 respectively represent a download selecting key, an upload selecting key, and a play key, which are expressed in an image (icon) form instead of a character (test) form.

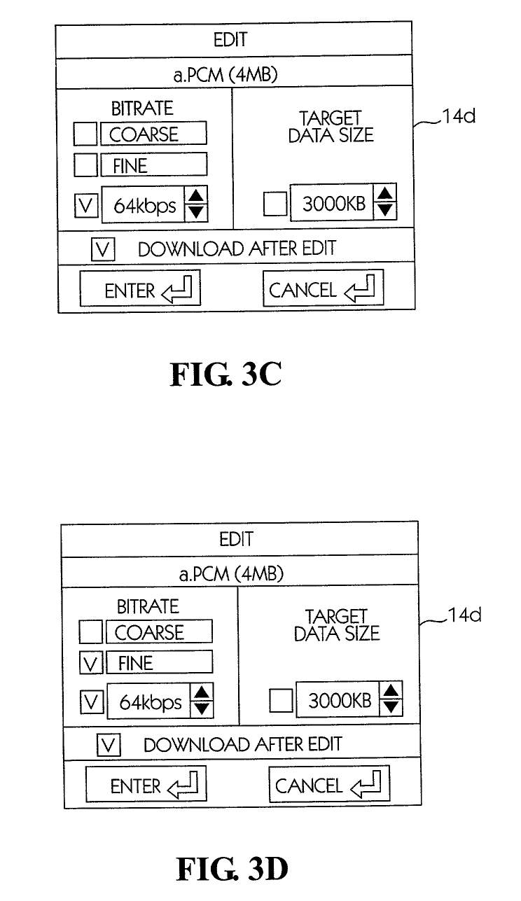

The process of editing an audio file according to a user's desired scale by using the audio editor 18 will be described below with reference to FIGS. 1-4.

First, when the audio editor 18 is executed, an initial screen (see FIG. 2) is displayed (step 100). On the initial screen, a menu item is displayed by the menu providing portion 18a, and a file list of the memory device 16 of the computer 10 and a file list of a memory portion of an external device (i.e., portable digital audio player) connected to a predetermined communication port of the computer 10, are displayed. Simultaneously, the total memory size and the amount of remaining free memory space of the memory portion of the external device are also displayed for the users reference during the editing process. If there is no external device connected to the computer 10, only the file list of the computer 10 is displayed.

When the user selects one file from the file list stored in the memory device 16 of the computer 10, for example, when the user selects an <a.pcm> audio file (blocked in a dotted line) through the manipulation of the inputting device 15 such as a mouse or keyboard, the editing portion 18b displays the size of the selected file, for example 4 Megabytes, in a lower portion of the display window shown in FIG. 2. It should be noted here that more than one file may be selected for editing, and as such, the BSAC method is applied to all the selected files.

Next, it is determined whether a selection of a menu item is made from the menu or not (step 110). If not, then it is determined whether or not the user makes a selection, e.g. [symbol] (in the upper right corner of the display screen), for closing the initial screen to effectively end the audio editing job (step 115).

When the selection of a menu item is made from the menu in step 110, it is determined whether the EDIT menu is selected or not (step 120). If not, then the process corresponding to the selected menu item is performed (step 125).

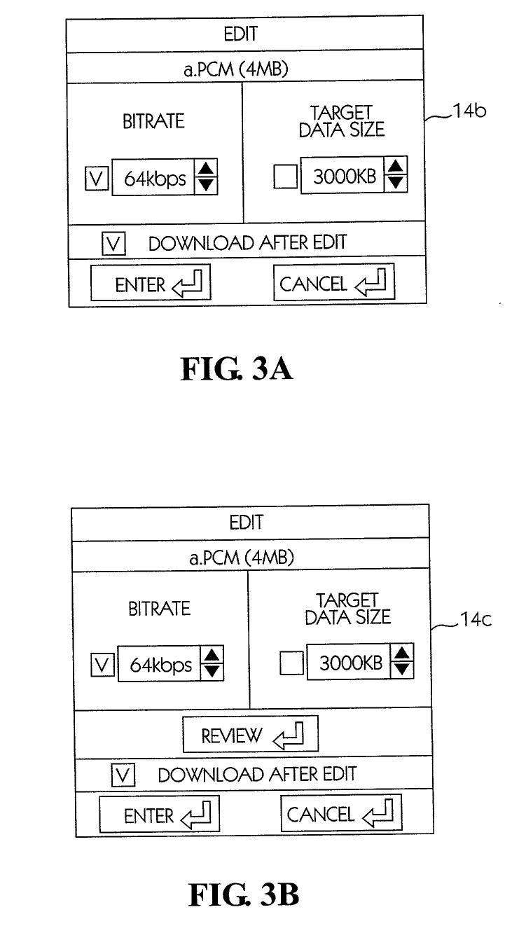

When it is determined, in step 120, that the user selected the EDIT menu through the manipulation of the inputting device 15 a data extraction rate selection menu (see FIGS. 3A˜3D) is displayed. Preferably, the menu providing portion 18a provides a menu for selecting a bit rate and/or a target data size by the completion of the editing process. Here, the bit rate selecting menu is for the user's convenience to select data size and audio quality of the audio file in consideration of an audio file type. The fact to be considered is that the higher bit rate causes a higher audio quality with larger data size, while a lower bit rate causes lower audio quality but with a smaller data size.

Meanwhile, the selection menu for target data size by the completion of the editing process is for the user's convenience to edit the audio file to an adjusted scale which is suitable for the free capacity of the recording medium in which she/he intends to store the editing completed audio file. For example, the user can conveniently use this menu when she/he wants to adjust and store the audio file of more than 3 Megabytes in the portable digital audio player having a free capacity of 3 Megabytes.

As shown in FIG. 3A, a data extraction rate selecting menu window 14b displays a file <a.pcm> selected to be edited, a bit rate selecting window, a target data size selecting window, and a post-edit process selecting window. In a second embodiment, as shown in FIG. 3B, a preview key is also provided in data extraction rate selecting menu window 14c to allow the user to sample or preview the quality of the audio file according to the selected bit rate or target size prior to editing and downloading. In a third embodiment, as shown in FIGS. 3C and 3D, a data extraction rate selecting menu window 14d displays a file <a.pcm> selected to be edited, a bit rate selecting window, a target data size selecting window, coarse and fine adjustment tools in the bit rate selecting window and a post-edit process selecting window. It should be apparent that the third embodiment could also include a preview key as shown in FIG. 3B.

When it is determined that the data extraction rate is selected in step 130, by selecting one of the bit rate or target size (described in more detail below), the editing portion 18b edits the audio file by the layered Bit Sliced Arithmetic Coding (BSAC) method (step 140) according to the bit rate or target size set by the user through the extraction rate selecting menu window of FIGS. 3A˜3D.

After completion of the editing, when it is determined that the downloading is set (steps S150 and S160), the edited audio file is downloaded to the digital audio player connected to the computer 10 (step 170). With respect to FIG. 3B, however, if the user desires to audibly preview the results of the editing the user selects the preview key after selecting one of the bit rate or target size, then a portion of the audio file is edited (encoded) by the BSAC method stored in, for example, a temporary file. The encoded audio portion is then automatically decoded and audibly played. If the user accepts the quality of the edited audio, then the user may set the download function, and after selecting the enter [symbol] key the entire file will be edited by the BSAC method and downloaded (steps 140 through 170).

Meanwhile, when the downloading is not selected in step 160, a new screen (not shown) is displayed requesting the user to name the edited data file, which is then stored at a predetermined location (step 180).

Referring again to FIGS. 3A˜3D, the bit rate is preferably selected at 1 Kbps intervals, while the target data size is selected at 1 Kilobyte intervals. However, the bit rate may also be selected at intervals more or less than 1 Kbps, for example, 8 Kbps, and the target data size selected at intervals more or less than 1 Kbyte, for example, 500 Kbytes, with the support of the bit sliced codec program of the editing portion 18b.

Among the extraction rate selecting menu, when the user wants to select only a bitrate of the audio file, she/he manipulates a scroll bar (up and down arrows) of the bit rate selecting window to her/his desired bit rate. When the user sees her/his desired bit rate in the bit rate selecting window, she/he stops manipulating the scroll bar, and clicks a selection confirming box formed at the left of the bit rate selecting window to mark a check mark (V) therein. When the user sees the check mark (V) in the selection confirming box, she/he selects whether to download or not, and clicks accordingly.

When the scroll bar for the bit rate is manipulated by the user, the display for target data size may change to display a value corresponding to the displayed bit rate. Accordingly, where the target data size display is limited to displaying only the default intervals of, for example, 500 Kbytes, i.e., 0, 500, 1000 . . . 6000 KB, when using the scroll bar corresponding to the target data size, by using the scroll bar corresponding to the bit rate the displayed target data size will change to one corresponding to the displayed bit rate and thus will not be limited to the 500 Kbyte interval.

Additionally, when a user manipulates the scroll bar corresponding to the target data size, then the display corresponding to the bit rate value may change to display a bit rate corresponding to the displayed target data size, which may be outside the default bit rate interval.

In the third embodiment the bit rate is preferably selected at 1 Kbps intervals for fine adjustment and the bit rate is preferably selected at 8 Kbps intervals for coarse adjustment. Accordingly, when the coarse adjustment tool is selected, as shown in FIG. 3C, manipulation of the bit rate scroll bar will display bit rates at 8 Kbps intervals, i.e., 8, 16, 24, 32, 40, 48, 56, 64 . . . n Kbps. When the fine adjustment tool is selected, as shown in FIG. 3D, manipulation of the bit rate scroll bar will display bit rates at 1 Kbps intervals, i.e., of 1, 2, 3, . . . , 62, 63, 64 . . . n Kbps. And, as described above, when the scroll bar for the bit rate is manipulated by the user, the display for target data size may change to display a value corresponding to the displayed bit rate.

As will described below, the encoded audio data will include a header that contains bitrate information. Accordingly, the selected bit extraction rate, for example, 8 Kbps per layer and the value of the highest layer, for example 64 Kbps, will be included in the header of the encoded audio signal.

When the selected audio file for downloading has already been generated by the layered BSAC method, extraction is performed from a layer corresponding to the selected bit rate.

When the user wants to play the edit completed file, she/he selects her/his desired file and clicks a play key 27 provided by the menu providing portion 18a. Accordingly, the audio editor 18 decodes the selected audio file, and outputs the file to an audio output device (not shown) such as a speaker connected to the computer 10.

As described above, the audio editor 18 according to the present invention can be recorded in the recording medium for use. Also, when the audio editor 18 is installed in the computer 10, the user can edit the audio file on the computer 10 to a scale as she/he wishes. After editing the audio file by the layered BSAC method as she/he wishes, the user can use the audio file by downloading the edit completed file to a memory of a portable digital audio player having a device capable of decoding and playing the audio file.

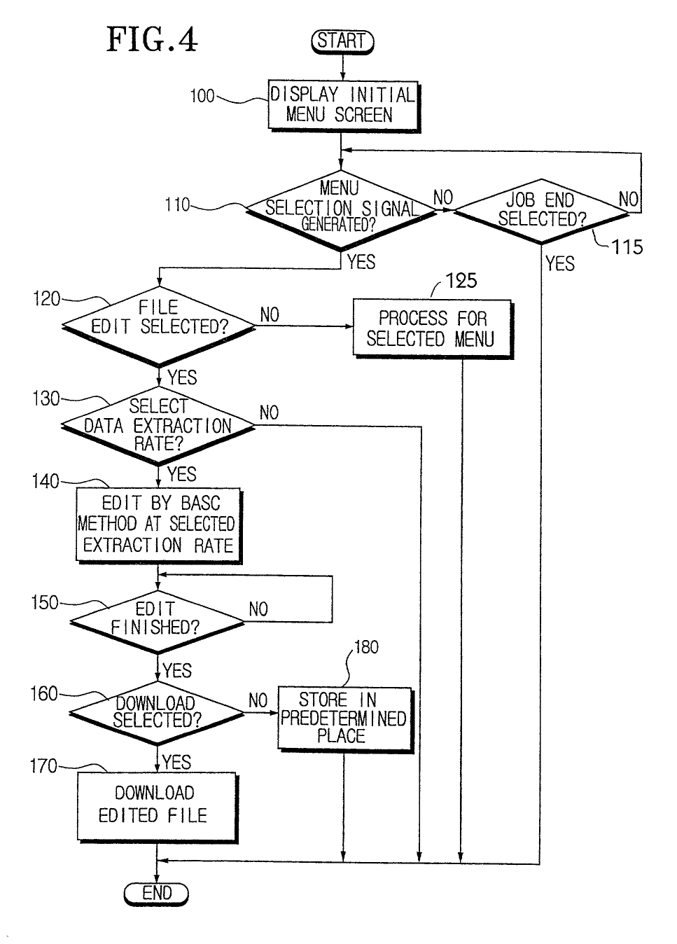

Meanwhile, according to another aspect of the present invention, a digital audio player may edit an audio file by itself. FIG. 5A is a block diagram showing a digital audio player according to one preferred embodiment of the present invention. As shown in FIG. 5A, the digital audio player 30 is connected to a computer 60 via a communication interface 50. A reference numeral 70 refers to the Internet connected to the computer 60. Thus, it is not necessary for computer 60 to include editing portion 18b of FIG. 1.

The digital audio player 30 includes a key input portion 31, a controller 32, a display portion 33, a memory 35, a bit sliced codec portion 37, an A/D converter 39, a D/A converter 41, and an interface 49. The reference numeral 43 refers to an internal microphone (MIC), 45 refers to an analog audio signal input terminal, while 47 refers to an analog audio signal output terminal.

It is preferable that the interface 49 is constructed to perform bi-directional communication with the computer 60 through a parallel port of the computer 60 such as a parallel port for a printer, or a serial port such as USB, and also through a cable 50.

Alternatively, the interface 49 is constructed to perform bi-directional communication with the computer 60 or an external device by a wireless communication method.

The key input portion 31 includes a plurality of keys for setting various supporting functions. The key input portion 31 also includes an key 31a for processing and storing a received audio signal at a desired extraction rate. Key 31a may be termed an options key for displaying a plurality of menu options on display portion 33, wherein one of the displayed options may be an editing or encoding option which will cause display portion 33 to display a screen similar to that shown in FIG. 5B. Additionally, key 31a may be termed an editing key which will cause display portion 33 to immediately display a screen similar to that shown in FIG. 5B. The display portion 33 displays information received from the controller 32. The controller 32 processes signals input through the key input portion 31, and accordingly controls the respective components.

Further, the key input portion 31 preferably includes save, play, stop, and record keys which are not shown in the drawings. The keys can be separately formed, or one key can have a plurality of functions which are distinguishable by a predetermined manipulation thereof.

The A/D converter 39 converts an analog signal input through the input terminal 45 or through the microphone (MIC) 43 into a digital signal.

The D/A converter 41 converts a digital signal output from the controller 32 into an analog signal, and outputs the analog signal through the output terminal 47. There can be a plurality of output terminals 47 formed for connecting an earphone, an external device, etc.

The bit sliced codec 37 includes an encoder for performing an encoding process by the layered BSAC method and a decoder for performing a decoding process for the encoded signal by the layered BSAC method.

When an edit signal is input, the controller 32 provides a screen for displaying the amount of free memory remaining in memory 35, and a bit rate and/or a target data size selecting menu on the display portion 33. Note, however, that controller 32 could provide information with respect to the amount of free memory space available in memory 35 at all times, that is, prior to the activation of key 31b.

Considering a relatively smaller display capacity of the display portion 33 of the digital audio player 30, the screen about the bit rate selection menu and/or target data size selecting menu can be sequentially displayed according to a screen move manipulation of the key input portion 31. The intervals of the bit rate and target data size selections are applied with the same as described above with respect to FIGS. 1-4.

When a data extraction rate is selected through the key input portion 31, the controller 32 extracts the audio data input through one of paths of the input portion, i.e., microphone 43, input terminal 45, and interface 49, according to the layered bit sliced arithmetic coding method, and stores the extracted data in the memory portion, i.e., in the memory 35.

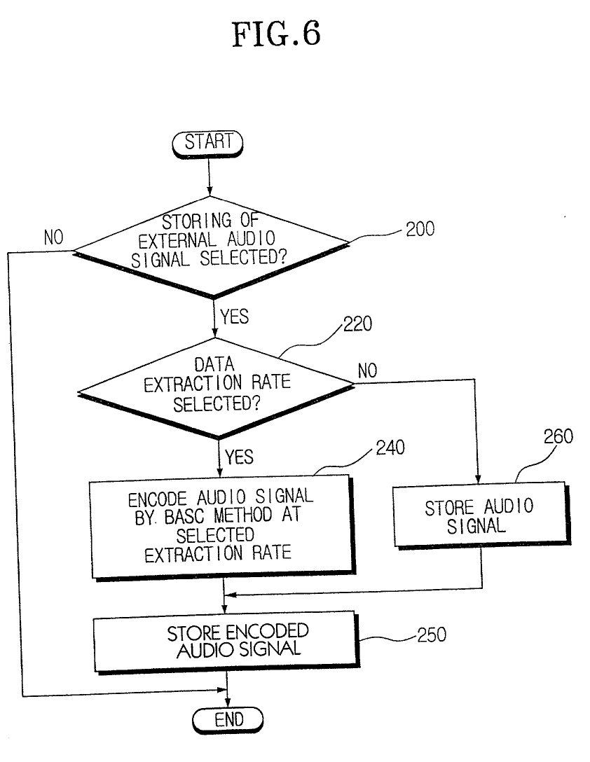

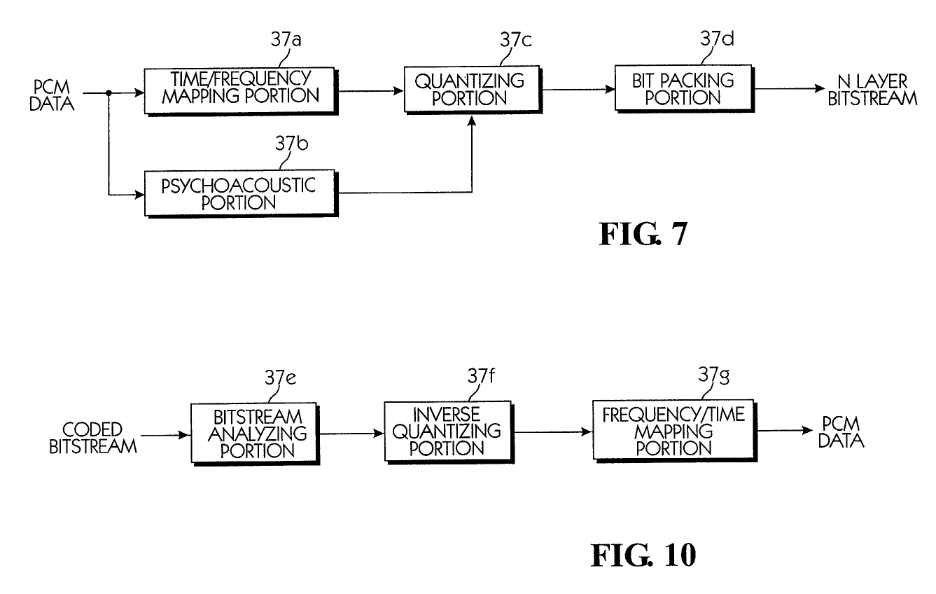

For example, when a bit stream audio data generated by the layered BSAC method is input from the computer 60 through the interface 49, the controller 32 stores the data in the memory 35 until the bit rate of the layer reaches the selected rate, or until the bytes of the data reach the selected target data size. After reaching the selected rate or bytes, the data is not stored, as will be better understood from the discussion of FIGS. 8 and 9, below.

Meanwhile, when the data input through the interface 49 is determined to be generated by the audio data formats other than the layered BSAC method such as a Pulse Code Modulation (PCM), the controller 32 loads the bit sliced codec portion 37 to encode the data according to the layered BSAC method to a predetermined extraction rate. Then the controller 32 stores the data in the memory 35. The type of the audio data can be determined from header information. That is, bitrate information is contained in the header. Accordingly, the selected bit extraction rate, for example, 8 Kbps per layer and the value of the highest layer, for example 64 Kbps, will be included in the header of the encoded audio signal. Thus, a method exhibiting the best efficiency in reproducing the encoded audio data can be obtained by accessing the information stored in the header. For example, when audio data is encoded by an encoder at a bitrate of 96 Kbps, for example, the best quality sound can be restored by a decoder corresponding to the encoder having a bitrate of 96 Kbps.

When the data is an analog signal input through the microphone 43 or the input terminal 45, the data is converted into digital data which is sampled at a predetermined sampling rate by the A/D converter 39. Then, the data is encoded by the bit sliced codec portion 37 according to a selected extraction rate, and stored in the memory 35.

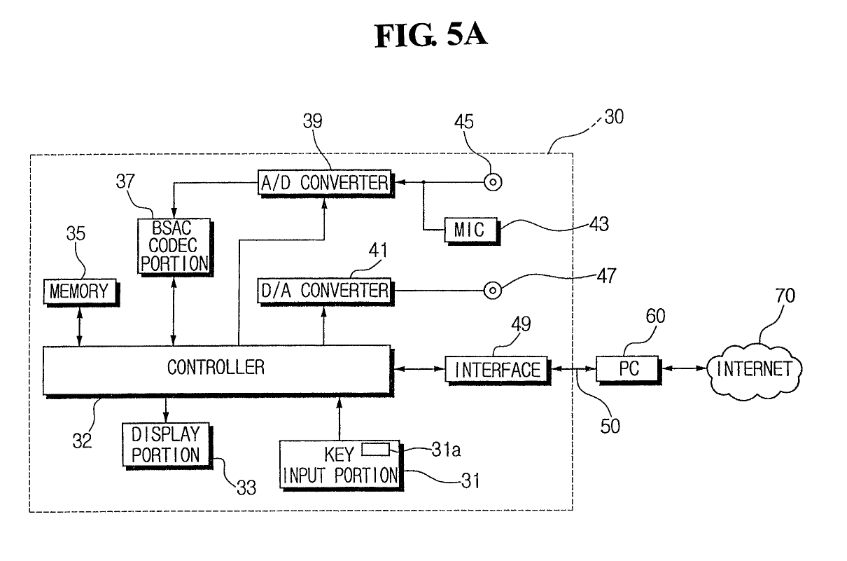

A data editing process of the digital audio player will be described below with reference to FIG. 6. Here, it should be understood that the user has preferably already selected either a desired data extraction rate by selection of a bit rate or a target data size using, for example, the data extraction rate selecting menu window 14e of FIG. 5B. It should also be understood that, although FIGS. 5A and 5B are directed to a portable digital audio player, the digital audio player can also be computer generated and displayed on a screen of the computer having an options key 31a, and activation of the options key would result in a display as shown in FIG. 2 and activation of the edit key on the menu bar would result in a display either as shown in FIG. 5B or as shown in any of FIGS. 3A-3D.

First, it is determined whether a storing select signal is input with respect to an external audio signal or not (step 200). Here, the external signal is a signal input through the input portion, i.e., through the interface 49, microphone 43, or input terminal 45. Also, the storing select signal includes a signal generated from manipulation of, for example, a store or record key, on the key input portion 31, and a control signal indicating the beginning of a download from outside.

When the storing select signal is input, it is determined whether or not the data extraction rate is selected (step 220). When the data extraction rate is determined to be selected, the received audio signal is encoded by the layered bit sliced arithmetic coding (BSAC) method according to the selected extraction rate (step 240). The encoded audio signal is then stored in the memory 35 (step 250).

Meanwhile, when the received audio signal is already bitstream coded by the layered BSAC method, the data is stored until the bit rate layer of the received signal reaches the the selected extraction rate corresponding to either the selected bit rate or selected target data size, which means step 240 will be omitted in this case.

When it is determined that the extraction rate is not selected in step 220, the received audio signal is directly stored in the memory 35 (step 260). Alternatively, in step 260 the audio signal may be encoded by the bit sliced arithmetic coding method according to a predetermined default bitrate and then stored in memory 35.

The process of encoding audio data by the layered bit sliced arithmetic coding method with the bit sliced codec 37 or the audio editor 18 according to the predetermined extraction rate according to the present invention will be described below in greater detail. Meanwhile, note that the layered BSAC coding and decoding methods as employed in the present invention are similarly disclosed in U.S. Pat. Nos. 6,122,618 and 6,148,288 both to Sung-hee Park and entitled Scalable Audio Coding/Decoding Method And Apparatus, which are incorporated by reference herein. Also incorporated by reference are U.S. patent application Ser. No. 09/106,016 to Sung-hee Park et al. entitled Scalable Stereo Audio Encoding/Decoding Method And Apparatus filed Jun. 29, 1998, and U.S. patent application Ser. No. 09/084,893 to Sung-hee Park et al. entitled Scalable Audio Encoding/Decoding Method And Apparatus filed May 28, 1998.

First, the layered bit sliced encoding and decoding methods will be schematically described.

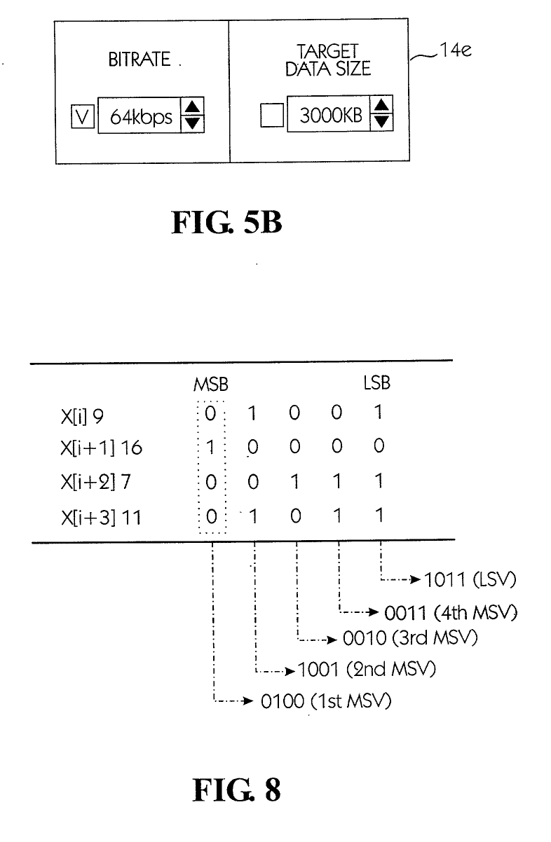

Referring to FIG. 7 showing the bit sliced encoder of the bit sliced codec portion 37, the layered bit sliced encoder includes a time/frequency mapping portion 37a, a psychoacoustic portion 37b, a quantizing portion 37c, and a bit packing portion 37d.

The time/frequency mapping portion 37a converts audio signals of a temporal domain into signals of a frequency domain. The signals in the frequency domain greatly differ from each other according to a human psychoacoustic model (e.g. ISO/IEC 1117 2-3) from a signal perceptible by a human to a signal imperceptible. Accordingly, by differing the bits allocated in the respective frequency bandwidths, the compression efficiency can be increased.

The psychoacoustic portion 37b couples the converted signals by signals of predetermined subbands by the time/frequency mapping portion 37a and calculates a masking threshold at each subband using a masking phenomenon generated by interaction with the respective signals. With the masking threshold, a minimum level of signal, which has sound but imperceptible to the human due to the size of the input signal and interaction of the respective signals, can be obtained.

The quantizing portion 37c quantizes the signals for each predetermined coding band so that the quantization noise of each band becomes smaller than the masking threshold. In other words, the frequency signals of each band are applied to scala quantization so that the magnitude of the quantization noise of each band is smaller than the masking threshold, so as to be imperceptible. Quantization is performed so that the Noise-to-Mask Ratio (NMR) value, which is a ratio for the masking threshold calculated by the psychoacoustic portion 37b to the noise generated at each band, is less than or equal to 0 dB. The NMR value less than or equal to 0 dB means that the masking threshold is higher than the quantization noise. In other words, the quantization noise is not audible.

In order to accomplish the scalable audio codec, the bit packing portion 37d combines the frequency data quantized by the quantizing portion 37c with side information about the respective subbands and the quantized information of the audio data according to the bitrate of the respective layers.

FIG. 8 shows an example where the value quantized to 5 bits is represented in a binary notion. According to the layered method, the most significant bits are coupled and first encoded. For example, when encoding in 4 bit unit, the binary numbers 0100 (blocked by dots) (corresponding to the Most Significant Vector; MSV) are first encoded. Then the encoding is proceeded one vector by vector to the least significant bits. In such a situation, the bits are efficiently compressed into encodes by using proper possibility distribution and arithmetic coding method. Bitstream structure generated by the above methods is shown in FIG. 9.

That is, the encoder encodes the audio signal into a layered bitstream structure consisting of a 0 base layer and a plurality of enhancement layers. Each layer consists of a header region, side information writing region, and a data region.

The base layer has the lowest bit rate, and the next enhancement layer has the bit rate higher than the base layer by predetermined intervals of bit rate. In this manner, the enhancement layers have increasing bit rates at certain intervals.

Only the MSBs are represented in the forehand of the base layer, so that only the contour for the all frequency components is encoded. As more bits are represented in lower bits, more detailed information can be expressed. Since detail information data values are encoded according to increasing bitrates, i.e., enhancement of layers, and audio quality can be improved.

Next, a method for constructing a scalable bitstream using the data expressed as above will be described. First, among side information to be used for the base layer, quantization bit information for each quantizing band is encoded. The information of quantized values is sequentially encoded from the MSBs to the LSBs, and from low frequency components to high frequency components. If quantiztion bits of a certain band are less than those of the band being currently encoded, encoding is not performed. When quantization bits of the band equal to those of the band being currently encoded, encoding is performed. Here, if there is no band restriction in encoding signals of the respective layers, sound objectionable to the ear may be generated. This is because signals are on and off when restoring signals of the layers having low bitrates, in the case of performing encoding from the MSB to the LSB, irrespective of bands. Thus, it is advisable to restrict bands appropriately according to bitrates.

After the base layer is encoded, the side information and quantized value of audio data for the next enhancement layer are encoded. In such a manner, data of all layers corresponding to the selected bit rate are encoded. The thus-encoded information is collected altogether to form bitstreams.

As shown in FIG. 9, the bitstream made by the encoder has a layered structure in which the lowest layer bitstream is contained in the higher layer bitstream.

The audio signal with such a layered structure is coded from more important signal components to a less important signal components. Using the thus-formed bitstreams, bitstreams having a low bitrate can be formed by simply rearranging the low bitrate bitstreams contained in the bitstream having the highest bitstream, by a user's request. In other words, bitstreams formed by encoder on a real time basis, or bitstreams stored in a medium, can be rearranged to be suitable for a desired bitrate by a user's request, to then be transmitted. Also, if the user's hardware performance is poor or the user wants to reduce the complexity of a decoder, even with appropriate bitstreams, only some bitstreams can be restored, thereby controlling the complexity.

For example, when bitrate is selected to 64 Kbps, the bitstream is constitute for top layer to be 64 Kbps from the predetermined base layer. Accordingly, in forming a scalable bitstream, the bitrate of a base layer is 16 Kbps, that of a top layer is 64 Kbps, and the respective enhancement layers has bitrate intervals of 8 Kbps, that is, the bitstream has 7 layers of 16, 24, 32, 40, 48, 56 and 64 Kbps. Since the bitstream formed by the encoder has a layered structure, the bitstream of the top layer of 64 Kbps contains the bitstreams of the respective layers (16, 24, 32, 40, 48, 56 and 64 Kbps). If a user requests data for the top layer, the bitstream for the top layer is transmitted without any processing thereof. Also, if another user requests data for the base layer (corresponding to 16 Kbps), only the forehand bitstreams are simply transmitted.

The respective layers have limited bandwidths according to bitrates, and the end quantization bands are different. When input data is a PCM data sampled at 48 KHz, and the magnitude of one frame is 1024, the number of bits usable for one frame for a bitrate of 64 Kbps is 1365.3333(=64000 bits/sec*(1024/48000)) on the average. Similarly, the number of bits usable for one frame can be calculated according to the respective bitrates.

When an extraction rate is selected, the bitrate of the top layer for the selected extraction rate is determined, and accordingly, bitstreams are generated from the bitrates of the base layer to the targeting layer at selected bitrate intervals by the encoding process according to the layered BSAC method.

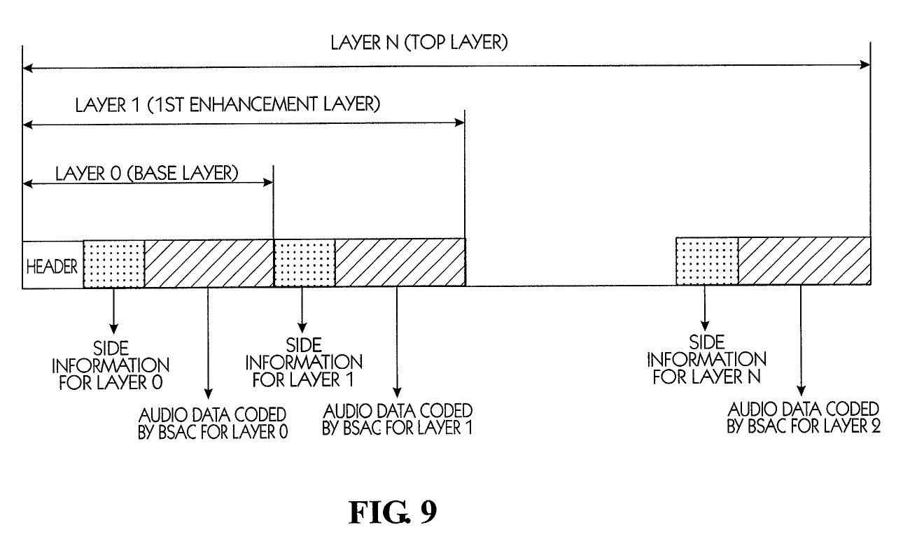

Meanwhile, as shown in FIG. 10, the decoder includes a bitstream analyzing portion 37e, an inverse quantizing portion 37f, and a frequency/time mapping portion 37g.

The bitstream analyzing portion 37e performs decoding process by an order that the respective layers are generated. Also, the bitstream analyzing portion 37e performs decoding process for the respective layers by an order of importance of the bits of the respective bitstreams.

The inverse quantizing portion 37f restores the data decoded by the bitstream analyzing portion 37e into a signal of an original magnitude.

The frequency/time mapping portion 37g converts audio signal inverse-quantized to be in a frequency domain to signal in a temporal domain.

The decoded signal is converted to analog signal through the D/A converter and output through the output terminal 47 during playing process.

As described above, according to the audio data editing method and recording medium employing the editing method, and digital audio player of the present invention, since the audio data file can be efficiently edited at any scale, the memory capacity of the digital audio devices can be utilized more efficiently.

What is claimed is:

1. A digital audio player for storing digital audio data in a memory portion, comprising:
a key input portion having a predetermined key for enabling adjustment of a data extraction rate with respect to an audio signal input through an input portion; and
a controller for encoding said audio signal received through the input portion according to an adjusted data extraction rate, and storing the encoded audio data in the memory portion.

2. The digital audio player as set forth in claim 1, further comprising a display for displaying a value indicative of an amount of free memory remaining in said memory portion as determined by said controller.

3. The digital audio player as set forth in claim 1, wherein said predetermined key provides, when activated by a user, a predetermined key signal to the controller and said controller displays a menu on a display, in response to said key signal, a bitrate adjustment tool for selecting a bitrate at predetermined kilobyte per second intervals and a target data size tool for selecting a target data size at predetermined kilobyte intervals, said data extraction rate being adjusted according to a selected bitrate or a selected target data size.

4. The digital audio player as set forth in claim 3, wherein said display displays a value indicative of an amount of free memory remaining in said memory portion, as determined by said controller, in response to said key signal.

5. The digital audio player as set forth in claim 1, further comprising a bit-sliced arithmetic codec portion, wherein said controller loads said bit-sliced arithmetic codec portion for encoding said audio signal received through the input portion by a bit sliced arithmetic coding method according to the adjusted data extraction rate, and storing the encoded audio data as a file in the memory portion, said controller further loads said bit-sliced arithmetic codec portion for decoding, by the bit sliced arithmetic coding method, the file stored in the memory portion for reproducing said audio signal.

6. The digital audio player as set forth in claim 3, further comprising a bit-sliced arithmetic codec portion, wherein said controller loads said bit-sliced arithmetic codec portion for encoding said audio signal received through the input portion by a bit sliced arithmetic coding method according to the adjusted data extraction rate, and storing the encoded audio data as a file in the memory portion, said controller further loads said bit-sliced arithmetic codec portion for decoding, by the bit sliced arithmetic coding method, the file stored in the memory portion for reproducing said audio signal.

7. The digital audio player as set forth in claim 1, wherein said input portion includes:
an interface for supporting a bi-directional communication with a computer;
a microphone for receiving an audio signal from a user
an analog audio signal input terminal for receiving an analog audio signal from an external source; and
analog-to-digital converter for converting an audio signal received via said microphone or said analog audio signal input terminal.

8. The digital audio player as set forth in claim 3, wherein said input portion includes:
an interface for supporting a bi-directional communication with a computer;
a microphone for receiving an audio signal from a user
an analog audio signal input terminal for receiving an analog audio signal from an external source; and
analog-to-digital converter for converting an audio signal received via said microphone or said analog audio signal input terminal.

9. The digital audio player as set forth in claim 8, further comprising a bit-sliced arithmetic codec portion, wherein said controller loads said bit-sliced arithmetic codec portion for encoding said audio signal received through the input portion by a bit sliced arithmetic coding method according to the adjusted data extraction rate, and storing the encoded audio data as a file in the memory portion, said controller further loads said bit-sliced arithmetic codec portion for decoding, by the bit sliced arithmetic coding method, the file stored in the memory portion for reproducing said audio signal.

10. The digital audio player as set forth in claim 9, wherein said controller, upon receipt of bitstream data formed according to a layered bit sliced arithmetic coding method and received via said interface, stores the received bitstream data until a bit rate layer corresponding to the selected bit rate is received, such that bit rate layers greater than the selected bit rate are discarded.

11. The digital audio player as set forth in claim 9, wherein said controller, upon receipt of bitstream data formed according to a layered bit sliced arithmetic coding method and received via said interface, stores the received bitstream data until the amount of bitstream data stored corresponds to the selected target data size, and any remaining bitstream data is discarded.

12. The digital audio player as set forth in claim 1, wherein the digital audio player is portable.

13. The digital audio player as set forth in claim 1, wherein the digital audio player is computer generated.

14. The digital audio player as set forth in claim 5, wherein the bit-sliced arithmetic codec portion comprises:
a quantizing portion for quantizing input audio data for predetermined coding bands; and
a bit packing portion for generating a layered bitstream by an order of bit significance, by expressing the quantization data in a binary notion of a predetermined number of bits, coupling the data in bit unit, and encoding the data from a top bit sequence having the most significant bits to a lower bit sequence having the least significant bits.

15. The digital audio player as set forth in claim 5, wherein the bit sliced codec portion comprises:
a bitstream analyzing portion for analyzing bit significance of the bits composing the bitstreams and decoding the layered bitstreams by an order of layer generation, from the most significant bit to the least significant bit;
an inverse-quantizing portion for restoring the data decoded by the bitstream analyzing portion into an original-sized signal; and
a frequency/time mapping portion for converting the audio signal in a frequency domain inversely quantized by the inverse-quantizing portion into a signal in a temporal domain.

16. The digital audio player as set forth in claim 13, wherein said key input portion comprises a menu bar, and said predetermined key comprises an edit key on said menu bar.

17. The digital audio player as set forth in claim 12, further comprising a bit-sliced arithmetic codec portion, wherein said controller loads said bit-sliced arithmetic codec portion for encoding said audio signal received through the input portion by a bit sliced arithmetic coding method according to the adjusted data extraction rate, and storing the encoded audio data as a file in the memory portion, said controller further loads said bit-sliced arithmetic codec portion for decoding, by the bit sliced arithmetic coding method, the file stored in the memory portion for reproducing said audio signal.

18. The digital audio player as set forth in claim 17, wherein said controller, upon receipt of bitstream data formed according to a layered bit sliced arithmetic coding method and received via said interface, stores the received bitstream data until a bit rate layer corresponding to the selected bit rate is received, such that bit rate layers greater than the selected bit rate are discarded.

19. The digital audio player as set forth in claim 17, wherein said controller, upon receipt of bitstream data formed according to a layered bit sliced arithmetic coding method and received via said interface, stores the received bitstream data until the amount of bitstream data stored corresponds to the selected target data size, and any remaining bitstream data is discarded.

20. The digital audio player as set forth in claim 13, wherein said predetermined key provides, when activated by a user, a predetermined key signal to the controller and said controller displays a menu on a display, in response to said key signal, a bitrate adjustment tool for selecting a bitrate at predetermined kilobyte per second intervals and a target data size tool for selecting a target data size at predetermined kilobyte intervals, said data extraction rate being adjusted according to a selected bitrate or a selected target data size.

21. The digital audio player as set forth in claim 20, wherein said controller comprises an audio editor including:
a menu providing portion for providing a display showing various menus of audio editing; and
an editing portion for performing a layered bit sliced coding of the audio signal.

22. The digital audio player as set forth in claim 21, wherein said editing portion comprises a bit-sliced arithmetic codec program for encoding said audio signal received through the input portion by a bit sliced arithmetic coding method according to the adjusted data extraction rate, and storing the encoded audio data as a file in the memory portion, said editing portion further loads said bit-sliced arithmetic codec program for decoding, by the bit sliced arithmetic coding method, the file stored in the memory portion for reproducing said audio signal.

23. The digital audio player as set forth in claim 21, wherein said predetermined kilobyte per second intervals comprise 1 Kbps intervals.

24. The digital audio player as set forth in claim 21, wherein said predetermined kilobyte intervals comprise 1 Kbyte intervals.

25. A computer having a digital audio editor for encoding an audio signal according to a layered bit sliced arithmetic coding method and storing the encoded audio signal in a memory, said audio editor comprising:
a menu providing portion for providing a display showing various menus of audio editing wherein said menu providing portion displays a key input portion having a predetermined key for enabling adjustment of a data extraction rate; and
an editing portion for performing layered bit sliced coding of the audio signal according to an adjusted data extraction rate, and storing the encoded audio signal in the memory.

26. The audio editor as set forth in claim 25, wherein said editing portion comprises a bit-sliced arithmetic codec program for encoding said audio signal by said bit sliced arithmetic coding method according to the adjusted data extraction rate, and storing the encoded audio signal as a file in the memory, said editing portion further loads said bit-sliced arithmetic codec program for decoding, by the bit sliced arithmetic coding method, the file stored in the memory for reproducing said audio signal.

27. The audio editor as set forth in claim 26, wherein said predetermined key provides, when activated by a user, a predetermined key signal to the menu providing portion and said menu providing portion displays a predetermined menu on a display screen of said computer, in response to said key signal, a bitrate adjustment tool for selecting a bitrate at predetermined kilobyte per second intervals and a target data size tool for selecting a target data size at predetermined kilobyte intervals, said data extraction rate being adjusted according to a selected bitrate or a selected target data size.

28. The audio editor as set forth in claim 27, wherein said predetermined kilobyte per second intervals comprise 1 Kbps intervals.

29. The audio editor as set forth in claim 27, wherein said predetermined kilobyte intervals comprise 1 Kbyte intervals.

30. The audio editor as set forth in claim 27, wherein said key input portion comprises a menu bar, and said predetermined key comprises an edit key on said menu bar.

31. The audio editor as set forth in claim 27, wherein said menu providing portion provides a display showing a file menu, said file menu menu comprising:
a first menu bar including said key input portion and said predetermined key comprises and edit key;
a second menu bar positioned below said first menu bar, said second menu bar including a download key, an upload key and a play key;
a split screen having a left display screen and a right display screen, said left display screen displaying file folders stored in memory of said computer, said right display screen displaying files stored in a memory of a portable digital audio player when said portable digital audio player is connected to an output port of said computer;
a file size display portion for displaying a size of one of said file folder selected by a user for further processing; and
a memory size display for displaying a total memory size of said memory of said portable digital audio player and displaying a value indicative of an amount of available free memory space in said memory of said digital audio player.

32. The audio editor as set forth in claim 31, wherein said menu providing portion provides an edit menu as said predetermined menu displayed on said display screen when said edit key is activated by said user, said edit menu comprising:
said bitrate adjustment tool, said bitrate adjustment tool including a bitrate display for showing selectable bit rate values and bitrate scroll means for scrolling through said selectable bit rate values; and
said target data size tool, said target data size tool including a target data size display for showing selectable target data size values and target data size scroll means for scrolling through said selectable target data size values.

33. The audio editor as set forth in claim 32, wherein said edit menu further comprises a download after edit key for enabling said encoded audio signal to be automatically downloaded to the memory of said portable digital audio player upon completion of said layered bit sliced coding of said audio signal.

34. The audio editor as set forth in claim 33, wherein said edit menu further comprises an enter key and a cancel key, said enter key being activated by said user to start said layered bit sliced coding of said audio signal, and said cancel key being activated by said user to close said edit menu without editing said audio signal.

35. The audio editor as set forth in claim 34, wherein said edit menu further comprises a preview key for enabling the user to sample a quality of an audio signal partially encoded by said layered bit sliced coding of said audio signal according to the selected bit rate or target size prior to downloading.

36. The audio editor as set forth in claim 34, wherein said predetermined kilobyte per second intervals comprise 1 Kbps intervals, said edit menu further comprising
a fine adjustment tool, said fine adjustment tool enabling said bitrate display to show selectable bit rate values in said 1 Kbps intervals; and
a coarse adjustment tool, said coarse adjustment tool enabling said bitrate display to show selectable bit rate values in 8 Kbps intervals.

37. A method of encoding an audio signal according to a layered bit sliced arithmetic coding program and storing the encoded audio signal in a memory, said method comprising the steps of:
displaying a main menu on a screen of said computer wherein said main menu includes a menu bar comprising a key input portion having a plurality of menu keys including a predetermined key for enabling adjustment of a data extraction rate;
determining whether a key signal is generated in response to activation of one of said menu keys;
determining, when it is determined that said key signal is generated, whether said key signal corresponds to said predetermined key;
determining whether a data extraction rate has been selected, when it is determined that said key signal corresponds to said predetermined key;
editing an audio signal file according to a bit-sliced arithmetic coding program at said data extraction rate, when it is determined that said data extraction rate has been selected, and outputting an encoded audio signal;
downloading said encoded audio signal to a memory of a portable digital audio player when said editing step is completed.

38. The method as set forth in claim 37, further comprising the steps of:
determining whether an automatic download function has been selected;
storing said encoded audio signal to a memory of said computer when said editing step is completed and it has been determined that said automatic download function has not been selected; and
performing said step of downloading when it is determined that said automatic download function has been selected.
